(19) United States
(12) Patent Application Publication
(10) Pub. No.: US 2007/0083498 A1
(43) Pub. Date: Apr. 12, 2007

(54) Distributed search services for electronic data archive systems

(76) Inventors: John C. Byrne, Rutherford, NJ (US); Satyendar Kumar, North Arlington, NJ (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/392,399

(22) Filed: Mar. 28, 2006

Related U.S. Application Data
(60) Provisional application No. 60/666,375, filed on Mar. 30, 2005.

(51) Int. Cl. G06F 17/30

(52) U.S. Cl. 707/3

(57) ABSTRACT

A method for searching index information in a data archive system. The method comprises: receiving a request to search a range of the index information for at least one search term; distributing different portions of the search request among a plurality of search engines, each search engine being responsible searching the index information for the search term over a predetermined portion of the range and providing the results of the search; and collecting the results from the plurality of search engines.

### CROSS-REFERENCE TO RELATED APPLICATION

This application claims the benefit under 35 U.S.C. §119(e) of copending, U.S. Provisional Application No. 60/666,375, filed Mar. 30, 2005, the disclosure of which is hereby incorporated by reference herein in its entirety.

### BACKGROUND

1. Field of the Invention

The present invention relates to electronic data archive systems. More particularly, the present invention relates to distributed search services for electronic data archive systems.

2. Description of the Related Art

In an information processing system, periodic archival of data may be necessary to insure the integrity of the data and to free-up local memory for handling more active data. This is particularly true for industries such as the healthcare and finance industries where government regulations require electronic communications (e.g., e-mail and text messages) and other electronic documents to be stored for months or years.

Typically, a data archive system copies data files to a high volume, but not necessarily fast access, form of storage such as magnetic tape, optical media, disk drive, and the like. The data archive system retains index information identifying the contents and location of the archived file in relatively fast access memory. In order to retrieve a file, a user inputs a search request indicating one or more search terms and the electronic data archive system searches the index information for files associated with the search terms. Upon identifying one or more files associated with the search terms, the electronic data archive system retrieves the files from the physical storage or provides the user with some indication of the files found in the search.

In addition to insuring the integrity of stored data, an electronic data archive system must provide the user with a reasonable response time for retrieval of the data. Problematically, the amount of archived data is typically very large, sometimes in the area of millions of messages, pages, or documents per day. As a result, a large amount of index information must be searched to retrieve the archived data. The searching of this large amount of data is time consuming and adversely affects response time.

### BRIEF SUMMARY OF THE INVENTION

The above-described drawbacks and deficiencies of the prior art are overcome or alleviated by a method for searching index information in a data archive system. The method comprises: receiving a request to search a range of the index information for at least one search term; distributing different portions of the search request among a plurality of search engines, each search engine being responsible searching the index information for the search term over a predetermined portion of the range and providing the results of the search; and collecting the results from the plurality of search engines. The range may be a date range. The method may be embodied in a data archive system, or may be embodied as a storage medium including machine-readable computer program code.

In one embodiment each search engine initiates a plurality of threads, each thread performing part of the portion of the search request provided to the search engine. In this embodiment, the range may be a date range and the part of the search performed by each thread may be a single day. Each search engine may include a main thread configured to periodically check for pending search requests and initiate the plurality of threads in response to the pending search requests. The main thread may be further configured to: determine if the text search index has been modified, and pause the plurality of threads to refresh the text search index in response to determining that the text search index has been modified.

The foregoing and other objects, and features of the present invention will become more apparent in light of the following detailed description of exemplary embodiments thereof.

### BRIEF DESCRIPTION OF THE DRAWINGS

The invention will be more fully understood from the following detailed description taken in conjunction with the accompanying drawings wherein like elements are numbered alike, and in which:

FIG. 1 depicts an example of an information processing system including an information processing system; and

FIG. 2 is a schematic diagram of a distributed search service in accordance with an embodiment of the present invention.

### DETAILED DESCRIPTION

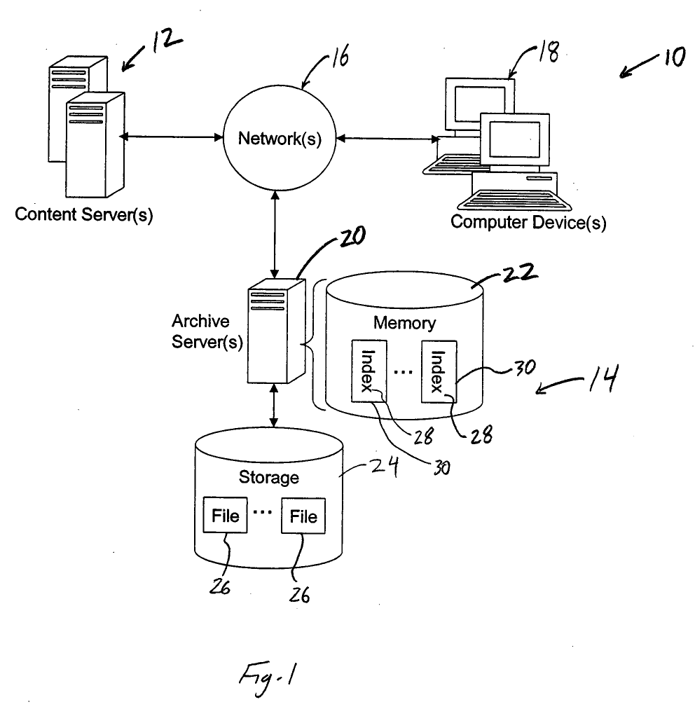

Referring to FIG. 1, an example of an information processing system is shown generally at 10. The information processing system 10 includes an electronic data archive system 14 coupled to one or more content server computers (content servers) 12 and computational devices 18 by a network 16. The electronic data archive system 14 includes one or more archive server computers (archive servers) 20, which have associated memory 22 and which are coupled to one or more storage devices 24. The storage devices 22 may include, for example, magnetic tape, optical media, disk drives, direct access storage (DAS), storage area networks (SAN), network attached storage (NAS), write once read many (WORM) technologies, and the like.

The content server computers 12 may include any one or more: e-mail servers, instant messaging servers, document servers, file servers, news servers, web servers and the like, which allow the computational devices 18 to access data via the network 16. The computational devices 18 may include any one or more: personal computers, workstation computers, laptop computers, handheld computers, palmtop computers, cellular telephones, personal digital assistants (PDAs), and any other devices capable of communicating digital information to the network 16. The network 16 may include any one or more of: a Wide Area Network (e.g., the Internet, an Intranet, and the like), a Local Area Network, a telephone network, and the like, and may employ any wired and/or wireless mode of communication. The information processing system 10 is shown for description only, and it will be appreciated that the present invention may be implemented in system topologies different from those shown in FIG. 1. For example, any of the content servers 12 may be programmed to provide the functionality described herein with respect to the archive server 20, thus eliminating the need for a separate archive server 20.

The archive server 20 executes software, such as for example, the Central Archive™ product commercially available from Axs-One Inc. of Rutherford N.J., which enables the archive server 20 to ingest, store, and manage files 26. “Files” as used herein may refer to any collection of data suitable for storing on a computational device or transferring within a network 16. In operation, the archive server 20 copies files 26 from the content servers 12 and/or the computational devices 18 to the storage device 22, and creates corresponding index information 28 identifying the contents of each file 26 and the location of each file 26 in storage 24. One common search indexing engine that may be employed by archive server 20 for creating index information 28 is commercially available from Fast Search & Transfer™ (FAST™) of Oslo, Norway as AltaVista Enterprise Search. The index information 28 is retained as one or more directories 30 in memory 22. For example, the index information 28 may include header information associated with electronic messages (e.g., e-mail or text messages), which typically includes such information as the date the message was sent and received, the sender and receiver of the message, the subject of the message, indication of attachments to the message, and at least a portion of the text of the message.

To retrieve a file 26, a user of a computational device 18 inputs a search request indicating one or more search terms, and the archive server 14 searches the index information 28 for the search terms to identify files 26 in storage 24 associated with the search terms. Upon identifying one or more files 26 associated with the search terms, the archive server 20 retrieves the files 26 from the storage 24 or provides the user of the computational device 18 with some indication of the files 26 found in the search (e.g., a hypertext link to the file 26, a count of the number of hits, and the like).

The archive server 20 typically organizes the index information 28 by date. For example, each day, week, or month may have its own directory 30 of index information 28. In prior art systems, to perform a search, a search component process implemented by software running on the archive server 20 opens up a directory 30 of index information 28 for one date, performs the search, closes the directory 30, and then does the same cycle for the next date based on the search request. As the amount of data archived by the system 10 increases, this process may result in increased response times for retrieval of the files 26.

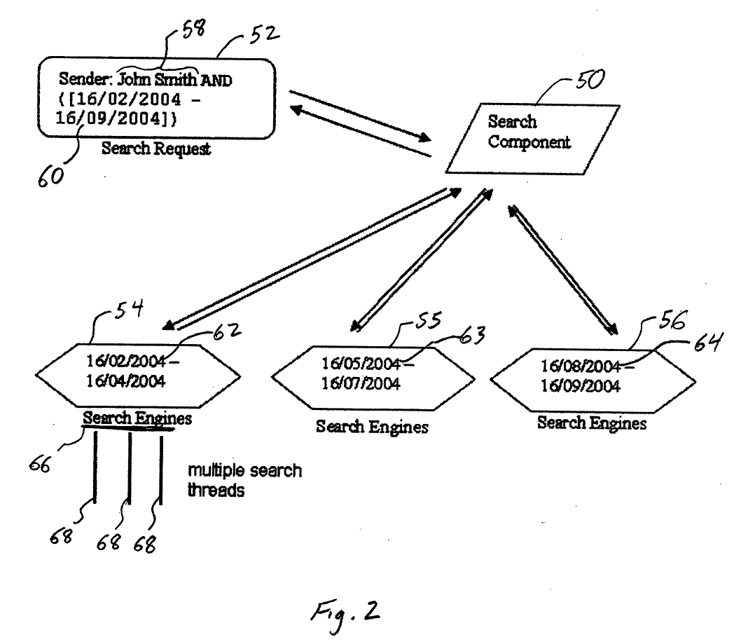

Referring to FIG. 1 and FIG. 2, the present invention provides a search component process (search component) 50 that distributes the workload for each search request 52. The search component 50 uses a set of dedicated search service processes (search engines) 54-56, rather than using traditional techniques of opening up the directories 30 of index information 28 directly in its own process space. This method allows the search to be conducted in parallel, and takes advantage of caching strategies for subsequent searches.

As shown in FIG. 2, each search request 52 includes a search term 58 and a range 60 of index information over which the search is to be conducted. The search component 50 receives the search request 52, breaks up the search request 52 into a plurality of search requests, based on the range 60, and submits each request to the proper search engine(s) 54-56. Each search engine 54-56 is responsible for conducting a portion of the search over its associated range 62-64 and returning the results of the search to the search component 50. It is contemplated that each search engine 54-56 may be responsible for more than one range. Furthermore, while three search engines 54-56 are shown, it will be appreciated that two or more search engines 54-56 may be used and that the number of search engines used is dependent upon many factors, including the amount of index information 26 and the computing resources of the archive server 20. The search engines 54-56 may be spawned as needed automatically.

In the embodiment shown, the range 60 provided in the search request 52 is a date range, and each search engine 54-56 is responsible for searching over an associated range of dates 62-64, respectively. For example, the search request 52 shown in FIG. 2 includes a search term 58 of “John Smith” and a range 60 from Feb. 16, 2004 to Sep. 16, 2004. In this example, the search component 50 will break the initial search request into: one or more search request for the term “John Smith” over the date range of Feb. 16, 2004 to Apr. 16, 2004 and provide this one or more request to search engine 54; one or more search request for the term “John Smith” over the date range of May 16, 2004 to Jul. 16, 2004 and provide this one or more request to search engine 55; and one or more search request for the term “John Smith” over the date range of Aug. 16, 2004 to Sep. 16, 2004 and provide this one or more request to search engine 56. The search engines 54-56 will conduct the search over their respective date ranges 62-64, and will provide the results of the search to the search component 50.

The search component 50 will wait for the results of each search engine 54-56, organize the results by date (i.e. wait for each date response in turn) and process the results using known techniques. For example, the search component 50 may retrieve the files 26 associated with the search result from the storage 24 and provide those files 26 to the user making the request. Alternatively, the search component 50 may provide the user with some indication of the files 26 found in the search (e.g., a hypertext link to the file 26, a count of the number of hits, and the like).

The search engines 54-56 themselves are each configured to wait for search requests from the search component 50, and to call the application programming interfaces (APIs) for the text search engine (e.g., the AltaVista Enterprise Search engine) to perform the searches. Each search engine 54-56 may have more than one thread that can perform a search. For example, each search engine 54-56 may have a main thread 66 that will open the directories 30 of index information 28 required for the respective date range 62, 63, or 64, and start one or more worker threads 68 to perform the search. The main thread 66 may create at least one worker thread 68 for each date in its range 62. The main thread 66 will periodically check the number of input search requests pending, and start new worker threads 68 as necessary (up to some configurable maximum). The main thread 66 checks the pending search requests by date, in order to determine the proper number of worker threads 68 for each date.

The worker threads 68 accept search requests from the input stream, call the text search engine APIs to perform the search, and send the reply back to the caller on its reply queue. Each worker thread 68 uses a global text search index handle established by the main thread 66.

In order to deal with changing directories 30 of index information 28, the main thread 66 will periodically check the ‘last modified’ date and time on the underlying directory 30. If the directory 30 has been updated and needs to be refreshed, the main thread 66 will pause any waiting worker thread 68, wait for all worker threads 68 to be ‘waiting’ and paused, close the directory 30, and re-open it. Most often, this would happen only for “current” dates, that is, dates associated with files 26 being actively stored in the archive storage 24.

After performing the search, the worker thread 68 reads the input queue to get more work. Prior to actually performing the search, each worker thread 68 first checks with the main thread 66 to confirm that it can continue, and after confirmation it performs the search. This allows the main thread 66 to pause the worker threads 68 to refresh the directories 30 as described above.

Search engines 54-56 are configured to provide the search component 50 with a count of the number of occurrences of the search term 58 for a particular search, as well as to identify of files 26 matching the search term 58 for the search. The count service is very useful as a means to identify the dates that actually have ‘hits’. In this way the user making the request can know very quickly the number of hits, and which dates have hits. Only those dates need to be subsequently re-examined for actual file content.

### EXAMPLES

A computer having 1 gigabyte (GB) of memory was programmed in accordance with an embodiment of the present invention. Indexes having a total index size of about 215 GB data (which is around 5-6 months of index data from instant messaging, regular e-mails etc.) were on a shared drive. The computer was operated to perform a variety of searches, and times for various actions were recorded. These times are as shown below:

Cache warm up times (happens only once, when service starts up)

Index warm up times varies according to index size:

| Index Size | Time taken |
|---|---|
| 60 GB | 30 seconds |
| 85 GB | 45 seconds |
| 120 GB | 90 seconds |
| 220 GB | 220 seconds |

Search time (count):
Varies according to index size and type of query (all times are average times)

Simple queries (searching for keywords):

| Index Size | Time taken |
|---|---|
| 60 GB | 2-3 seconds |
| 85 GB | 3-6 seconds |
| 120 GB | 6-9 seconds |
| 220 GB | 9-15 seconds |

Medium complexity queries (searching for few keywords separated by ‘and’ or ‘or’):

| | |
|---|---|
| 60 GB | 2-3 seconds |
| 85 GB | 3-6 seconds |
| 120 GB | 6-10 seconds |
| 220 GB | 15-20 seconds |

Very complex queries (searching for large number of keywords (100 or more) separated by ‘and’ or ‘or’ . . . ):

| | |
|---|---|
| 60 GB | 3-5 seconds |
| 85 GB | 8-10 seconds |
| 120 GB | 15-25 seconds |
| 220 GB | 25-40 seconds |

Result set fetch time:

Depending upon the number of hits I was able to fetch on average 10,000 hits in 0.5 second

The results of this testing revealed that the present invention provides cache warm-up times, search times, and fetch times that are significantly less than that possible with prior art systems. It is expected that the addition of another archive server would result in a decrease of 40% in response time from the above numbers. Advantageously, many simple machines working together can give a much better response time. It is believed that optimal response is with about 120 GB of index data per machine.

The present invention provides improved archive search performance by leveraging dedicated search engines to satisfy discrete components of the search request. Dedicated services can be deployed in a scalable fashion based on customer performance needs, date range requirements, etc. The end result is the search request is broken down to a granular level (‘a day, or a week, or a month’) and processed in parallel, thereby providing the search results back to the requestor in a significantly faster period of time.

The present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The computer systems described above are for purposes of example only. An embodiment of the invention may be implemented in any type of computer system or programming or processing environment.

It should be understood that any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

What is claimed is:

1. A method of searching index information in a data archive system, the method comprising:
receiving a request to search a range of the index information for at least one search term;
distributing different portions of the search request among a plurality of search engines, each search engine being responsible searching the index information for the search term over a predetermined portion of the range and providing the results of the search; and
collecting the results from the plurality of search engines.

2. The method of claim 1, wherein the range is a date range.

3. The method of claim 1, wherein each search engine initiates a plurality of threads, each thread performing part of the portion of the search request provided to the search engine.

4. The method of claim 3, wherein the range is a date range and the part of the search performed by each thread is a single day.

5. The method of claim 3, wherein each search engine includes a main thread configured to periodically check for pending search requests and initiate the plurality of threads in response to the pending search requests.

6. The method of claim 5, wherein the main thread is further configured to:
determine if the text search index has been modified, and
pause the plurality of threads to refresh the text search index in response to determining that the text search index has been modified.

7. An electronic data archive system comprising:
a search component configured to:
receive a request to search a range of index information for at least one search term,
distribute different portions of the search request among a plurality of search engines, each search engine being responsible searching the index information for the search term over a predetermined portion of the range and providing the results of the search to the search component, and
collect the results from the plurality of search engines.

8. The system of claim 7, wherein the range is a date range.

9. The system of claim 1, wherein each search engine initiates a plurality of threads, each thread performing part of the portion of the search request provided to the search engine.

10. The system of claim 9, wherein the range is a date range and the part of the search performed by each thread is a single day.

11. The system claim 9, wherein each search engine includes a main thread configured to periodically check for pending search requests and initiate the plurality of threads in response to the pending search requests.

12. The system of claim 11, wherein the main thread is further configured to:
determine if the text search index has been modified, and
pause the plurality of threads to refresh the text search index in response to determining that the text search index has been modified.

13. A storage medium encoded with machine-readable computer program code for searching index information in a data archive system, the storage medium including instructions for causing a computer to implement a method comprising:
receiving a request to search a range of the index information for at least one search term;
distributing different portions of the search request among a plurality of search engines, each search engine being responsible searching the index information for the search term over a predetermined portion of the range and providing the results of the search; and
collecting the results from the plurality of search engines.

14. The storage medium of claim 13, wherein the range is a date range.

15. The storage medium of claim 13, wherein each search engine initiates a plurality of threads, each thread performing part of the portion of the search request provided to the search engine.

16. The storage medium of claim 15, wherein the range is a date range and the part of the search performed by each thread is a single day.

17. The storage medium of claim 15, wherein each search engine includes a main thread configured to periodically check for pending search requests and initiate the plurality of threads in response to the pending search requests.

18. The storage medium of claim 17, wherein the main thread is further configured to:
determine if the text search index has been modified, and
pause the plurality of threads to refresh the text search index in response to determining that the text search index has been modified.
